(19) United States
(12) Patent Application Publication
(10) Pub. No.: US 2026/0371079 A1
(43) Pub. Date: Nov. 19, 2026

(54) HANDLING MIGRATION STATUS INFORMATION IN MISSION CRITICAL NETWORK

(71) Applicant: Samsung Electronics Co., Ltd., Suwon-si, Gyeonggi-do (KR)

(72) Inventors: Kiran Gurudev KAPALE, Bangalore (IN); Arunprasath RAMAMOORTHY, Bangalore (IN)

(21) Appl. No.: 19/142,823

(22) PCT Filed: Jan. 8, 2024
(86) PCT No.: PCT/KR2024/000343

§ 371 Date: Jun. 24, 2025

(30) Foreign Application Priority Data
Jan. 7, 2023 (IN) 202341001490
Dec. 11, 2023 (IN) 2023 41001490

(51) Int. Cl. H04W 12/06; H04W 4/90; H04W 12/69; H04W 36/00

(52) U.S. Cl. CPC H04W 12/06; H04W 4/90; H04W 12/69; H04W 36/0038

(57) ABSTRACT

The disclosure relates to a 5G or 6G communication system for supporting a higher data transmission rate. A first server receives, from a client, a migration service authorization request message, wherein the migration service authorization request message is forwarded to a second server, obtains a migration service authorization response message from the second server, stores information regarding a second mission critical (MC) service identifier (ID) provided by the second server mapped to a first MC service ID provided by the first server, wherein the stored information is used for communication redirection in case of completion of MC service authorization at the first server.

### TECHNICAL FIELD

The embodiments disclosed herein generally relate to field of mission critical (MC) services that are used by public safety communities (such as police, military, fire services, ambulance crews, and many more) and railways in operations that require high reliability, speed, quick accessibility and low latency operational support. The invention relates to one of a critical feature used, in which the migration of MC service users is allowed to migrate to a partner MC system and return back to a primary MC system or migrate to another partner MC system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

In a first aspect of the disclosure, provided herein is a method performed by a first server, the method comprising: receiving, from a client, a migration service authorization request message, wherein the migration service authorization request message is forwarded to a second server; obtaining a migration service authorization response message from the second server; and storing information regarding a second mission critical (MC) service identifier (ID) provided by the second server mapped to a first MC service ID provided by the first server, wherein the stored information is used for communication redirection in case of completion of MC service authorization at the first server.

In a second aspect of the disclosure, provided herein is a method performed by a second server, the method comprising: obtaining a migration service authorization request message from a first server; storing information regarding a second mission critical (MC) service identifier (ID) provided by the second server mapped to a first MC service ID provided by the first server; and transmitting a migration service authorization response message, wherein the stored information is used for communication redirection in case of completion of MC service authorization at the first server.

In a third aspect of the disclosure, provided herein is a first server comprising: a transceiver; and at least one processor coupled to the transceiver, configured to: receive, from a client, a migration service authorization request message, wherein the migration service authorization request message is forwarded to a second server, obtain a migration service authorization response message from the second server, and store information regarding a second mission critical (MC) service identifier (ID) provided by the second server mapped to a first MC service ID provided by the first server, wherein the stored information is used for communication redirection in case of completion of MC service authorization at the first server.

In a fourth aspect of the disclosure, provided herein is a second server comprising: a transceiver; and at least one processor coupled to the transceiver, configured to: obtain a migration service authorization request message from a first server, store information regarding a second mission critical (MC) service identifier (ID) provided by the second server mapped to a first MC service ID provided by the first server, and transmit a migration service authorization response message, wherein the stored information is used for communication redirection in case of completion of MC service authorization at the first server.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 shows a flow diagram of existing mechanism of service authorization for migration to a partner mission critical (MC) system, according to an embodiment of the disclosure;

FIG. 2 shows a flow diagram of service authorization for migration to the partner MC system in which a migration status stored along with MC service IDs are used only after completing MC service authorization, according to an embodiment of the disclosure;

FIG. 3 shows a flow diagram of service de-authorization request initiated by a MC service user to update (e.g. to clear) the stored migration status information from a current migrated MC system, when the migrated MC service user migrates back to its primary MC system or to another partner system, according to an embodiment of the disclosure.

FIG. 4 shows a flow diagram of the service de-authorization request initiated by the primary MC server of the primary MC system of the migrated MC service user on receiving of the MC service authorization request at the primary MC system of migrated MC service user, according to an embodiment of the disclosure.

FIG. 5 shows a flow diagram of the service de-authorization request initiated by the primary MC server of the primary MC system of the migrated MC service user upon receiving of MC service authorisation notification at the primary MC system of migrated MC service user from another MC system to which MC service user has migrated—to update (e.g. to clear) the stored migration status information, according to an embodiment of the disclosure;

FIG. 6 shows various hardware components of the partner MC server, according to an embodiment of the disclosure;

FIG. 7 shows various hardware components of the primary MC server, according to an embodiment of the disclosure;

FIG. 8A and FIG. 8B are flow charts illustrating a method, implemented by the partner MC server, for handling migration status information of the MC service user migrating in a MC network, according to an embodiment of the disclosure; and

FIG. 9 is a flow chart illustrating a method, implemented by the primary MC server, for handling migration status information of a MC service user migrating in a MC network, according to an embodiment of the disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Various embodiments of the disclosure will now be described in detail with reference to the accompanying drawings. In the following description, specific details such as detailed configuration and components are merely provided to assist the overall understanding of these embodiments of the disclosure. Therefore, it should be apparent to those skilled in the art that various changes and modifications of the embodiments described herein can be made without departing from the scope of the disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In mission critical services for public safety and railways, the migration of mission critical (MC) service users is allowed to migrate to a partner MC system and return back to a primary MC system or migrate to another partner MC system. In other words, the MC service user is allowed to migrate from the primary MC system to the partner MC system and return back to the primary MC system or migrate to another partner MC system. During a migration procedure, a migration status of the MC service user is stored in a MC system (i.e., primary MC system and partner MC system) along with MC service identifiers (IDs) from both the primary MC system and the partner MC system, in order to route the call appropriately. If the call is received for the migrating MC service user before the completion of MC service authorization at the MC system to which MC service user is migrated (returning to the primary MC system or migrating to the partner MC system), the call is routed but the call can't be completed.

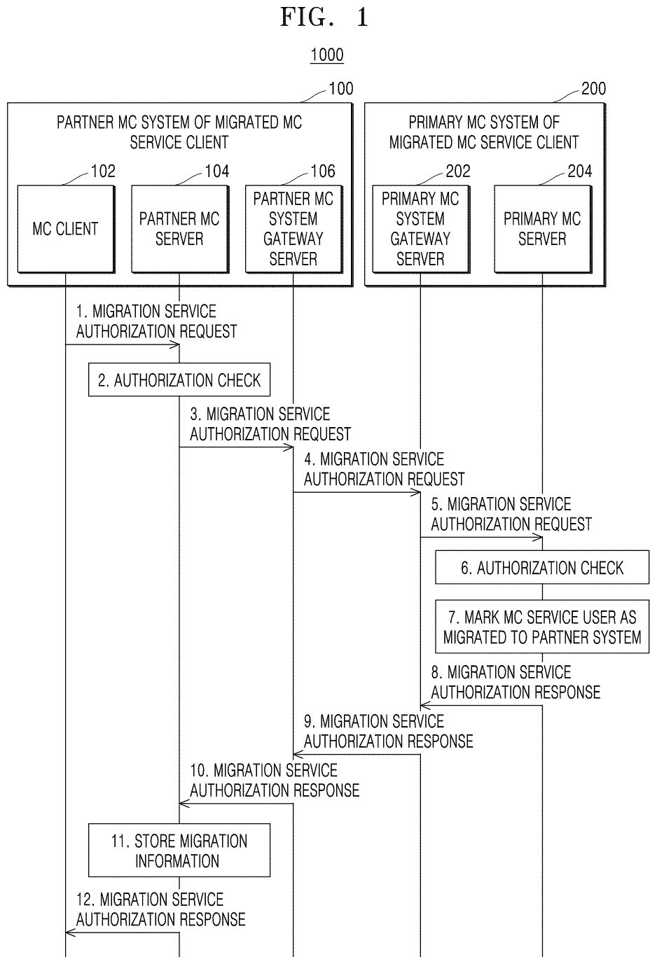

FIG. 1 shows a flow diagram of existing systems for service authorization for migration to a partner MC system (100), according to an embodiment of the disclosure. The service authorization for migration to the partner MC system (100) allows the MC service user to migrate to the partner MC system (100). To start receiving the service from the partner MC system (100), the MC service user has to complete the MC service authorization procedure at the partner MC system (100). If the MC service user receives the call after the service authorization for migration to the partner MC system (100) and before the MC service authorization at the partner MC system (100), the call is routed to the partner MC system (100) but the call can't be completed. Thus, it is important to use the stored information to route the call only after completing the MC service authorization.

As shown in FIG. 1, at step 1, the MC client (i.e., MC service client) (102) sends a migration service authorization request to a partner MC server (i.e., partner MC service server) (104). At step 2, the partner MC server (104) performs the authorization check for the migration service authorization request. After the authorization check, at step 3, the partner MC server (104) sends the migration service authorization request to a partner MC system gateway server (106). At step 4, the partner MC system gateway server (106) sends the migration service authorization request to the primary MC system gateway server (202). At step 5, the primary MC system gateway server (202) sends the migration service authorization request to a primary MC server (i.e., primary MC service server) (204).

At step 6, the primary MC server (204) performs the authorization check for the migration service authorization request. At step 7, the primary MC server (204) marks the MC service user as migrated to the partner system. At step 8, the primary MC server (204) sends a migration service authorization response to the primary MC system gateway server (202). At step 9, the primary MC system gateway server (202) sends the migration service authorization response to the partner MC system gateway server (106). At step 10, the partner MC system gateway server (106) sends the migration service authorization response to the partner MC server (104). At step 11, the partner MC server (104) stores the migration information. At step 12, the partner MC server (104) sends the migration service authorization response to the MC client (102).

The above information is presented as background information only to help the reader to understand the present invention. Applicants have made no determination and make no assertion as to whether any of the above might be applicable as prior art with regard to the present application.

The principal object of the embodiments herein is to provide a method and a MC network for handling migration status information of a MC service user migrating in the MC network.

Another object of the embodiments herein is to update and use migration status information in the MC network.

Another object of the embodiments herein is to provide a MC service user service authorisation notification. The MC service user service authorisation notification describes an information flow about a notification for successful completion of a MC service user service authorisation after migrating to a partner MC system.

Another object of the embodiments herein is to add a successful completion of MC service authorisation in a migration service authorization procedure before using a stored necessary information both in a primary MC system and a partner MC system related to the migrated MC service user for a proper communication redirection.

Another object of the embodiments herein is to adda pre-condition of successful completion of MC service authorisation in a migration service de-authorization procedure initiated by the primary MC server before sending the migration service deauthorization notification to the partner MC system when migrated MC service user returns back to its primary MC system.

Another object of the embodiments herein is to indicate the primary MC system of the migrated user about the successful completion of MC service authorisation at newly migrated MC system in which the MC service user service authorisation notification information flow is used to send the notification from one MCPTT server of MC system to the another MCPTT server of MC system. This notification helps the primary MC system to inform the partner MC system (previously migrated MC system) to update the stored necessary information related to the migrated MC service user accordingly.

Embodiments disclosed herein provide a method for handling migration status information of a MC service user migrating in a MC network. The method includes receiving, by a partner MC server, a migration service authorization request message for migrating an MC service user associated with a MC client. Further, the method includes transmitting, by the partner MC server, the migration service authorization request message for migration service authorisation to a primary MC server for migrating the MC service user. Further, the method includes receiving, by the partner MC server, a migration service authorization response message from the primary MC server for successful completion of the migration service authorization when the MC service user is migrated to the partner MC server. The migration service authorization response message includes a migration authorization status information of the MC service user. Further, the method includes storing, by the partner MC server, the migration status information of the MC service user associated with the MC client. The migration status information includes a MC service identifier of the MC service user provided by the primary MC system and the partner MC system and an service authorisation indication indicating the successful completion of the MC service authorisation when the MC service user is migrated to the partner MC server. Further, the method includes transmitting, by the partner MC server, the migration service authorization response message to the MC client, when the migration service authorization request message is received from the MC client. Further, the method includes receiving, by the partner MC server, a MC service authorisation request message for a MC service authorisation by the MC service user associated with the MC client. Further, the method includes transmitting, by the partner MC server, the MC service authorisation notification to the primary MC server to indicate about successful completion of the MC service authorisation at the partner MC server by migrating the MC service user. Further, the method includes transmitting, by the partner MC server, a MC service authorisation response message to the MC client, when the MC service authorisation request message is received from the MC client. Further, the method includes performing, by the partner MC server, a MC communication with the MC service user based on the stored migration status information of the MC service user.

In an embodiment, performing, by the partner MC server, the MC communication with the MC service user based on the stored migration status information includes mapping, by the partner MC server, the MC service identifier of the MC service user available in the stored migration status information of the MC service user to the MC service identifier of at least one of the partner MC server and the primary MC server, and performing, by the partner MC server, the MC communication with the MC service user based on the mapping.

In an embodiment, the method includes receiving, by the partner MC server, a migration service deauthorization request message from the MC service user for deauthorization of the migration of the MC service user from the partner MC server. Further, the method includes determining, by the partner MC server, whether the MC client is authorized for migration service deauthorization of the MC service user. Further, the method includes updating, by the partner MC server, the stored status information of the MC service user based on the migration service deauthorization of the MC service user. The updated migration status information of the MC service user allows redirection of the MC communication back to the primary MC system when the migrated MC service user is no longer migrated on the partner MC server. Further, the method includes transmitting, by the partner MC server, a migration service deauthorization response message to the migrated MC service user.

In an embodiment, the method includes receiving, by the partner MC server, a MC call information from the MC service user of the partner MC server for migrated MC service user. Further, the method includes routing, by the partner MC server, the MC call information to the primary MC server based on the updated status information of the migrated MC service user.

In an embodiment, the method further includes receiving, by the partner MC server, a migration service deauthorization notification message from the primary MC server for deauthorization of the migration of the MC service user from the partner MC server. Further, the method includes updating, by the partner MC server, the stored status information of the MC service user based on the migration service deauthorization of the MC service user.

In an embodiment, the migration service deauthorization notification message is received from the primary MC server through a partner MC system gateway server and a primary MC system gateway server.

In an embodiment, the migration service authorization request message is transmitted to the primary MC server through a partner MC system gateway server, and a primary MC system gateway server.

In an embodiment, the migration service authorization response message is received from the primary MC server through a partner MC system gateway server, and a primary MC system gateway server.

Embodiments disclosed herein provide a method for handling migration status information of a MC service user migrating in a MC network. The method includes receiving, by a primary MC server, a migration service authorization request message from a partner MC server. The migration service authorization request message is for migrating the MC service user associated with a MC client to the partner MC server. Further, the method includes migrating, by the primary MC server, the MC service user to the partner MC server. Further, the method includes performing, by the primary MC server, a migration service authorisation for migrating the MC service user to the partner MC server. Further, the method includes storing, by the primary MC server, the migration status information of the MC service user associated with the MC client. The migration status information includes a MC service identifier of the MC service user provided by the primary MC system and the partner MC system and a service authorisation indication indicating the successful completion of the MC service authorisation when the MC service user is migrated to the partner MC server. Further, the method includes transmitting, by the primary MC server, a migration service authorization response message to the partner MC server. The migration service authorization response message includes the migration status information of the MC service user. Further, the method includes receiving, by the primary MC server, a MC service authorisation notification message to indicate about successful completion of the MC service authorisation at the partner MC server by migrating the MC service user associated with the MC client. Further, the method includes performing, by the primary MC server, a MC communication with the MC service user based on the stored migration status information of the MC service user.

In an embodiment, the method includes transmitting, by the primary MC server, a migration service deauthorization notification message to the partner MC server for deauthorization of the migration of the MC service user from the partner MC server. Further, the method includes updating, by the primary MC server, the stored status information of the MC service user based on the migration service deauthorization of the MC service user. The updated migration status information of the MC service user allows redirection of the MC communication appropriately. Further, the method includes receiving, by the primary MC server, a migration service deauthorization response message to the migrated MC service user.

In an embodiment, further, the method includes receiving, by the primary MC server, a MC service authorisation notification message to indicate about successful completion of the MC service authorisation at current partner MC server by migrating the MC service user associated with the MC client. Further, the method includes transmitting, by the primary MC server, a migration service deauthorization notification message to the previous partner MC server for deauthorization of the migration of the MC service user from the previous partner MC server. Further, the method includes updating, by the primary MC server, the stored status information of the MC service user based on the migration service deauthorization of the MC service user. The updated migration status information of the MC service user allows redirection of the MC communication appropriately. Further, the method includes receiving, by the primary MC server, a migration service deauthorization response message to the migrated MC service user.

Embodiments disclosed herein provide a partner MC server for handling migration status information of a MC service user migrating in a MC network. The partner MC server includes a migration status information controller communicatively coupled to a memory and a processor. The migration status information controller is configured to receive a migration service authorization request message for migrating an MC service user associated with a MC client. Further, the migration status information controller is configured to transmit the migration service authorization request message for migration service authorisation to a primary MC server for migrating the MC service user. Further, the migration status information controller is configured to receive a migration service authorization response message from the primary MC server for successful completion of the migration service authorization when the MC service user is migrated to the partner MC server. The migration service authorization response message includes a migration authorization status information of the MC service user. Further, the migration status information controller is configured to store the migration status information of the MC service user associated with the MC client. The migration status information includes a MC service identifier of the MC service user provided by the primary MC system and the partner MC system and an service authorisation indication indicating the successful completion of the MC service authorisation when the MC service user is migrated to the partner MC server. Further, the migration status information controller is configured to transmit the migration service authorization response message to the MC client, when the migration service authorization request message is received from the MC client. Further, the migration status information controller is configured to receive a MC service authorisation request message for a MC service authorisation by the MC service user associated with the MC client. Further, the migration status information controller is configured to transmit the MC service authorisation notification to the primary MC server to indicate about successful completion of the MC service authorisation at the partner MC server by migrating the MC service user. Further, the migration status information controller is configured to transmit a MC service authorisation response message to the MC client, when the MC service authorisation request message is received from the MC client. Further, the migration status information controller is configured to perform a MC communication with the MC service user based on the stored migration status information of the MC service user.

Embodiments disclosed herein provide a primary MC server for handling migration status information of a MC service user migrating in a MC network. The primary MC server includes a migration status information controller communicatively coupled to a memory and a processor. The migration status information controller is configured to receive a migration service authorization request message from a partner MC server. The migration service authorization request message is for migrating the MC service user associated with a MC client to the partner MC server. Further, the migration status information controller is configured to migrate the MC service user to the partner MC server. Further, the migration status information controller is configured to perform a migration service authorisation for migrating the MC service user to the partner MC server. Further, the migration status information controller is configured to store the migration status information of the MC service user associated with the MC client. The migration status information includes a MC service identifier of the MC service user provided by the primary MC system and the partner MC system and a service authorisation indication indicating the successful completion of the MC service authorisation when the MC service user is migrated to the partner MC server. Further, the migration status information controller is configured to transmit a migration service authorization response message to the partner MC server. The migration service authorization response message includes the migration status information of the MC service user. Further, the migration status information controller is configured to receive a MC service authorisation notification message to indicate about successful completion of the MC service authorisation at the partner MC server by migrating the MC service user associated with the MC client. Further, the migration status information controller is configured to perform a MC communication with the MC service user based on the stored migration status information of the MC service user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Embodiments disclosed herein provide a method for handling migration status information of a MC service user migrating in a MC network. The method includes receiving, by a partner MC server, a migration service authorization request message for migrating an MC service user associated with a MC client. Further, the method includes transmitting, by the partner MC server, the migration service authorization request message for migration service authorisation to a primary MC server for migrating the MC service user. Further, the method includes receiving, by the partner MC server, a migration service authorization response message from the primary MC server for successful completion of the migration service authorization when the MC service user is migrated to the partner MC server. The migration service authorization response message includes a migration authorization status information of the MC service user. Further, the method includes storing, by the partner MC server, the migration status information of the MC service user associated with the MC client. The migration status information includes a MC service identifier of the MC service user provided by the primary MC system and the partner MC system and a service authorisation indication indicating the successful completion of the MC service authorisation when the MC service user is migrated to the partner MC server. Further, the method includes transmitting, by the partner MC server, the migration service authorization response message to the MC client, when the migration service authorization request message is received from the MC client. Further, the method includes receiving, by the partner MC server, a MC service authorisation request message for a MC service authorisation by the MC service user associated with the MC client. Further, the method includes transmitting, by the partner MC server, the MC service authorisation notification to the primary MC server to indicate about successful completion of the MC service authorisation at the partner MC server by migrating the MC service user. Further, the method includes transmitting, by the partner MC server, a MC service authorisation response message to the MC client, when the MC service authorisation request message is received from the MC client. Further, the method includes performing, by the partner MC server, a MC communication with the MC service user based on the stored migration status information of the MC service user.

In an embodiment of the disclosure, wherein performing, by the partner MC server, the MC communication with the MC service user based on the stored migration status information comprises: mapping, by the partner MC server, the MC service identifier of the MC service user available in the stored migration status information of the MC service user to the MC service identifier of at least one of the partner MC server and the primary MC server; and performing, by the partner MC server, the MC communication with the MC service user based on the mapping.

In an embodiment of the disclosure, the method comprises: receiving, by the partner MC server, a migration service deauthorization request message from the MC service user for deauthorization of the migration of the MC service user from the partner MC server; determining, by the partner MC server, whether the MC client is authorized for migration service deauthorization of the MC service user; updating, by the partner MC server, the stored status information of the MC service user based on the migration service deauthorization of the MC service user, wherein the updated migration status information of the MC service user allows redirection of the MC communication back to the primary MC system when the migrated MC service user is no longer migrated on the partner MC server; and transmitting, by the partner MC server, a migration service deauthorization response message to the migrated MC service user.

In an embodiment of the disclosure, the method comprises: receiving, by the partner MC server, a MC call information from the MC service user of the partner MC server for migrated MC service user; routing, by the partner MC server, the MC call information to the primary MC server based on the updated status information of the migrated MC service user.

In an embodiment of the disclosure, the method comprises: receiving, by the partner MC server, a migration service deauthorization notification message from the primary MC server for deauthorization of the migration of the MC service user from the partner MC server; and updating, by the partner MC server, the stored status information of the MC service user based on the migration service deauthorization of the MC service user.

In an embodiment of the disclosure, the migration service deauthorization notification message is received from the primary MC server through a partner MC system gateway server and a primary MC system gateway server.

In an embodiment of the disclosure, the migration service authorization request message is transmitted to the primary MC server through a partner MC system gateway server, and a primary MC system gateway server, and wherein the migration service authorization response message is received from the primary MC server through a partner MC system gateway server, and a primary MC system gateway server.

In an embodiment of the disclosure, a method for handling migration status information of a MC service user migrating in a Mission Critical (MC) network, comprising: receiving, by a primary MC server, a migration service authorization request message from a partner MC server, wherein the migration service authorization request message is for migrating the MC service user associated with a MC client to the partner MC server; migrating, by the primary MC server, the MC service user to the partner MC server; performing, by the primary MC server, a migration service authorisation for migrating the MC service user to the partner MC server; storing, by the primary MC server, the migration status information of the MC service user associated with the MC client, wherein the migration status information comprises a MC service identifier of the MC service user provided by the primary MC system and the partner MC system and a service authorisation indication indicating the successful completion of the MC service authorisation when the MC service user is migrated to the partner MC server; transmitting, by the primary MC server, a migration service authorization response message to the partner MC server, wherein the migration service authorization response message comprises the migration status information of the MC service user; receiving, by the primary MC server, a MC service authorisation notification message to indicate about successful completion of the MC service authorisation at the partner MC server by migrating the MC service user associated with the MC client; and performing, by the primary MC server, a MC communication with the MC service user based on the stored migration status information of the MC service user.

In an embodiment of the disclosure, wherein performing, by the primary MC server, the MC communication with the MC service user based on the stored migration status information comprises: mapping, by the primary MC server, the MC service identifier of the MC service user available in the stored migration status information of the MC service user to the MC service identifier of at least one of the partner MC server and the primary MC server; and performing, by the primary MC server, the MC communication with the MC service user based on the mapping.

In an embodiment of the disclosure, the method comprises: transmitting, by the primary MC server, a migration service deauthorization notification message to the partner MC server for deauthorization of the migration of the MC service user from the partner MC server; updating, by the primary MC server, the stored status information of the MC service user based on the migration service deauthorization of the MC service user, wherein the updated migration status information of the MC service user allows redirection of the MC communication appropriately; and receiving, by the primary MC server, a migration service deauthorization response message to the migrated MC service user.

In an embodiment of the disclosure, wherein the migration service deauthorization notification message is transmitted to the partner MC server through a partner MC system gateway server, and a primary MC system gateway server.

In an embodiment of the disclosure, wherein the migration service authorization request message is received from the partner MC server through a partner MC system gateway server, and a primary MC system gateway server, and wherein the migration service authorization response message is transmitted to the partner MC server through a partner MC system gateway server, and a primary MC system gateway server.

In an embodiment of the disclosure, the method comprises: receiving, by the primary MC server, a MC service authorisation notification message to indicate about successful completion of the MC service authorisation at current partner MC server by migrating the MC service user associated with the MC client; transmitting, by the primary MC server, a migration service deauthorization notification message to the previous partner MC server for deauthorization of the migration of the MC service user from the previous partner MC server; and updating, by the primary MC server, the stored status information of the MC service user based on the migration service deauthorization of the MC service user, wherein the updated migration status information of the MC service user allows redirection of the MC communication appropriately; and receiving, by the primary MC server, a migration service deauthorization response message to the migrated MC service user.

In an embodiment of the disclosure, a partner MC server for handling migration status information of a MC service user migrating in a Mission Critical (MC) network, comprising: a memory; a processor; and a migration status information controller, communicatively coupled to the memory and the processor, configured to: receive a migration service authorization request message for migrating an MC service user associated with a MC client; transmit the migration service authorization request message for migration service authorisation to a primary MC server for migrating the MC service user; receive a migration service authorization response message from the primary MC server for successful completion of the migration service authorization when the MC service user is migrated to the partner MC server, wherein the migration service authorization response message comprises a migration authorization status information of the MC service user; store the migration status information of the MC service user associated with the MC client, wherein the migration status information comprises a MC service identifier of the MC service user provided by the primary MC system and the partner MC system and a service authorisation indication indicating the successful completion of the MC service authorisation when the MC service user is migrated to the partner MC server; transmit the migration service authorization response message to the MC client, when the migration service authorization request message is received from the MC client; receive a MC service authorisation request message for a MC service authorisation by the MC service user associated with the MC client; transmit the MC service authorisation notification to the primary MC server to indicate about successful completion of the MC service authorisation at the partner MC server by migrating the MC service user; transmit a MC service authorisation response message to the MC client, when the MC service authorisation request message is received from the MC client; and perform a MC communication with the MC service user based on the stored migration status information of the MC service user.

In an embodiment of the disclosure, wherein perform the MC communication with the MC service user based on the stored migration status information comprises: map the MC service identifier of the MC service user available in the stored migration status information of the MC service user to the MC service identifier of at least one of the partner MC server and the primary MC server; and perform the MC communication with the MC service user based on the mapping.

In an embodiment of the disclosure, wherein the migration status information controller is configured to: receive a migration service deauthorization request message from the MC service user for deauthorization of the migration of the MC service user from the partner MC server; determine whether the MC client is authorized for migration service deauthorization of the MC service user; update the stored status information of the MC service user based on the migration service deauthorization of the MC service user, wherein the updated migration status information of the MC service user allows redirection of the MC communication back to the primary MC system when the migrated MC service user is no longer migrated on the partner MC server; and transmit a migration service deauthorization response message to the migrated MC service user.

In an embodiment of the disclosure, wherein the migration status information controller is configured to: receive a MC call information from the MC service user of the partner MC server for migrated MC service user; route the MC call information to the primary MC server based on the updated status information of the migrated MC service user.

In an embodiment of the disclosure, wherein the migration status information controller is configured to: receive a migration service deauthorization notification message from the primary MC server for deauthorization of the migration of the MC service user from the partner MC server; and update the stored status information of the MC service user based on the migration service deauthorization of the MC service user.

In an embodiment of the disclosure, wherein the migration service deauthorization notification message is received from the primary MC server through a partner MC system gateway server and a primary MC system gateway server.

In an embodiment of the disclosure, wherein the migration service authorization request message is transmitted to the primary MC server through a partner MC system gateway server, and a primary MC system gateway server, and wherein the migration service authorization response message is received from the primary MC server through a partner MC system gateway server, and a primary MC system gateway server.

In an embodiment of the disclosure, a primary MC server for handling migration status information of a MC service user migrating in a Mission Critical (MC) network, comprising: a memory; a processor; and a migration status information controller, communicatively coupled to the memory and the processor, configured to: receive a migration service authorization request message from a partner MC server, wherein the migration service authorization request message is for migrating the MC service user associated with a MC client to the partner MC server; migrate the MC service user to the partner MC server; perform a migration service authorisation for migrating the MC service user to the partner MC server; store the migration status information of the MC service user associated with the MC client, wherein the migration status information comprises a MC service identifier of the MC service user provided by the primary MC system and the partner MC system and a service authorisation indication indicating the successful completion of the MC service authorisation when the MC service user is migrated to the partner MC server; transmit a migration service authorization response message to the partner MC server, wherein the migration service authorization response message comprises the migration status information of the MC service user; receive a MC service authorisation notification message to indicate about successful completion of the MC service authorisation at the partner MC server by migrating the MC service user associated with the MC client; and perform a MC communication with the MC service user based on the stored migration status information of the MC service user.

In an embodiment of the disclosure, wherein perform the MC communication with the MC service user based on the stored migration status information comprises: map the MC service identifier of the MC service user available in the stored migration status information of the MC service user to the MC service identifier of at least one of the partner MC server and the primary MC server; and perform the MC communication with the MC service user based on the mapping.

In an embodiment of the disclosure, wherein the migration status information controller is configured to: transmit a migration service deauthorization notification message to the partner MC server for deauthorization of the migration of the MC service user from the partner MC server; update the stored status information of the MC service user based on the migration service deauthorization of the MC service user, wherein the updated migration status information of the MC service user allows redirection of the MC communication appropriately; and receive a migration service deauthorization response message to the migrated MC service user.

In an embodiment of the disclosure, wherein the migration service deauthorization notification message is transmitted to the partner MC server through a partner MC system gateway server, and a primary MC system gateway server.

In an embodiment of the disclosure, wherein the migration service authorization request message is received from the partner MC server through a partner MC system gateway server, and a primary MC system gateway server, and wherein the migration service authorization response message is transmitted to the partner MC server through a partner MC system gateway server, and a primary MC system gateway server.

In an embodiment of the disclosure, wherein the migration status information controller is configured to: receive a MC service authorisation notification message to indicate about successful completion of the MC service authorisation at current partner MC server by migrating the MC service user associated with the MC client; transmit a migration service deauthorization notification message to the previous partner MC server for deauthorization of the migration of the MC service user from the previous partner MC server; and update the stored status information of the MC service user based on the migration service deauthorization of the MC service user, wherein the updated migration status information of the MC service user allows redirection of the MC communication appropriately; and receive a migration service deauthorization response message to the migrated MC service user.

In general, the MC service allows the MC service user to migrate from a primary MC system to a partner MC system, migrate from the partner MC system to another partner MC system and return back to the primary MC system. The MC service users from the partner MC system or another partner MC system or primary MC system can communicate with the migrated MC service user. The migration of the MC service user is authorized by the primary MC system (e.g. MC System A) of the migrating MC service user whenever the MC service user is migrated from the primary MC system to the partner MC system (e.g. MC system B) or from migrated partner MC system to another partner MC system (e.g. MC system C). Once the MC service user is successfully authorized to migrate to the partner MC system by the primary MC system, the partner MC system which is a migrating MC system stores the migration status information along with the MC service IDs from both the primary MC system and the partner MC system. The stored information is used in order to route a call appropriately only after successful completion of MC service authorization at the MC system to which the MC service user is migrated (returning to the primary MC system or migrating to the partner MC system or migrate from the partner MC system to another partner MC system).

Similarly, the stored information about the migration status along with the MC service IDs are updated (e.g. cleared or set as user migrated out of the system) at previously migrated MC system when the MC service user return back to the primary MC system or migrate to another partner MC system. The update of the stored information is performed only after successful completion of MC service authorization at the primary MC system or another partner MC system to which user is migrated. In order to update the information at the previously migrated MC system, the primary MC system sends migration service de-authorization request or notification to previously migrated MC system. Another partner MC system is indicated to the migrating primary MC system about the service authorization on completing the successful MC service authorization, if the MC service user is migrated from the migrated MC system to another partner MC system. On receiving the successful MC service authorization notification, the migrating MC service user's primary MC system sends the migration service de-authorization request or notification to the previously migrated MC system. Similarly, when MC service user is returned back to the primary MC system, the primary MC system sends the migration service de-authorization request or notification to the previously migrated MC system on successful completion of the MC service authorization.

Based on the proposed method, the MC service user is allowed to migrate from the primary MC system to the partner MC system and return back to the primary MC system or migrate to another partner MC system. During the migration procedure, the migration status of the MC service user is stored in the MC system (Primary MC system and Partner MC system) along with the MC service IDs from both the primary MC system and the partner MC system, in order to route the call appropriately. If the call is received for the migrating MC service user before the completion of MC service authorization at the MC system to which MC service user is migrated (returning to the primary MC system or migrating to the partner MC system). The call is routed but the call can't be completed. In the scenario, the proposed invention helps in order to avoid the call failure during migration and MC service authorization procedures.

In the proposed method, below mechanism which aids in proper routing of a communication request in migration scenarios:
1. Only on successful completion of the MC service authorization at the migrating MC system, the method can be used to utilizes the stored information about MC service user's migration status along with the MC service IDs in order to route the call request appropriately.
2. Only on successful completion of the MC service authorization at migrating MC system, the method can be used to update (e.g. clear the information) the stored information at previously migrated MC system.

In Third Generation Partnership Project (3GPP), a 23.280 specification has defined the service authorization mechanism for migration to the partner MC system. The service authorization mechanism is used by the MC service user as a part of migration process. The migrating MC service user's primary MC system authorizes and marks that MC service user has migrated to the partner MC system. In the proposed method, the method can be used for receiving of successful authorization response by the partner MC system, the mapping of the MC service IDs obtained from the primary MC system and the partner MC system along with the migration status is stored. The stored information is used in order to route the call appropriately only after successful completion of MC service authorization at the MC system to which MC service user is migrating (returning to the primary MC system or migrating to the partner MC system or migrate from the partner MC system to another partner MC system).

Similarly, the stored information about the migration status along with the MC service IDs are updated (e.g. cleared or set as user migrated out of the system) at previously migrated MC system when the MC service user return back to the primary MC system or migrate to another partner MC system. The update of these information is performed only after successful completion of MC service authorization at the primary MC system or another partner MC system to which user is migrating. In order to update the stored information at previously migrated MC system, the primary MC system sends the migration service de-authorization request or notification to the previously migrated MC system. Another partner MC system indicates to the migrating primary MC system about the service authorization on completing the successful MC service authorization, if the MC service user is migrating from the migrated MC system to another partner MC system. For receiving the successful MC service authorization notification, the migrating primary MC system sends the migration service deauthorization request or notification to the previously migrated MC system. Similarly, when the MC service user is returned back to the primary MC system, the primary MC system sends the migration service de-authorization request or notification to the previously migrated MC system on successful completion of the MC service authorization.

The proposed method can be used for public safety agency and railways related requirement and is required procedure for a mission critical push-to-talk (MCPTT) service, a MCVideo service and a MCData service.

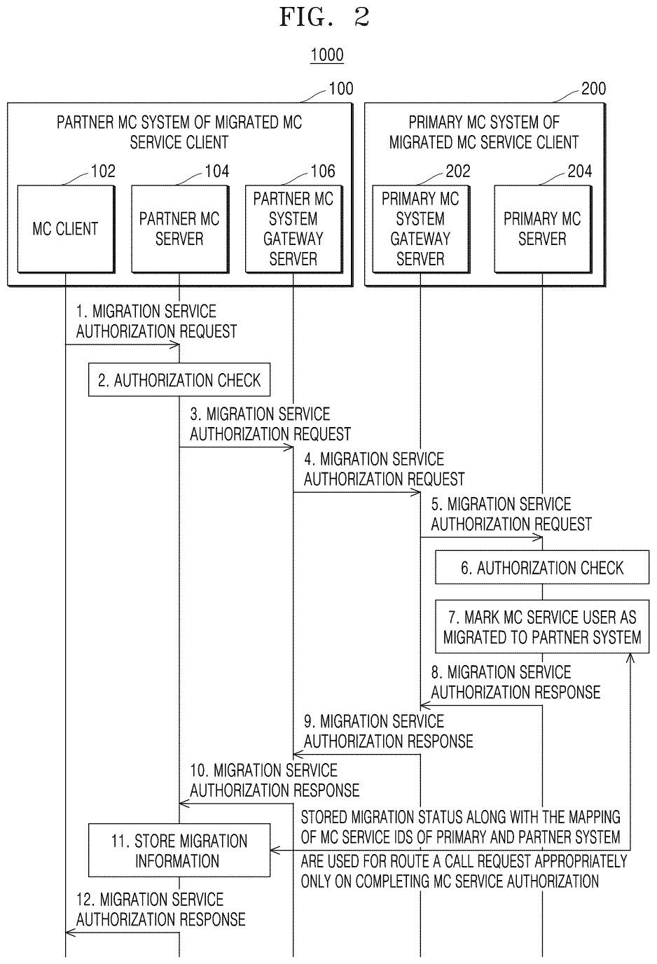

Referring now to the drawings and more particularly to FIGS. 2 through 9, where similar reference characters denote corresponding features consistently throughout the figures, there are shown preferred embodiments.

FIG. 2 shows the flow diagram of service authorization for migration to the partner MC system (100), in which the migration status stored along with MC service IDs are used only after completing MC service authorization in a MC network (1000), according to an embodiment of the disclosure.

The existing procedures defined in the specification of the 3GPP technical specification (TS) 23.280 are enhanced to include the new information about when to apply or use the stored migration status information along with the mapping of the MC service IDs obtained from the primary MC system and the partner MC system. The stored information is used to route the communication request appropriately only after successfully completing the MC service authorization by migrating MC service user at migrating MC system. This results into appropriate routing of the call and by successfully establishing the call with intended target MC service user.

Following additional information provided to clarify on the use of stored information related to the migrated MC service user in the existing procedure as defined in the subclause 10.6.3.3 of TS 23.280.

“The stored necessary information related to the migrated MC service user (e.g., MC service ID of the migrated MC service user provided by the primary MC system (200) mapped to the MC service ID of the migrated MC service user provided by the partner MC system (100) and the migration status information of the MC service user) is used for proper communication redirection only after successful completion of MC service authorization at the partner MC system (100) (i.e. migrated MC system).”

As shown in FIG. 2, at step 1, the MC client (102) sends a migration service authorization request to a partner MC server (104). At step 2, the partner MC server (104) performs the authorization check for the migration service authorization request. After the authorization check, at step 3, the partner MC server (104) sends the migration service authorization request to the partner MC system gateway server (106). At step 4, the partner MC system gateway server (106) sends the migration service authorization request to the primary MC system gateway server (202). At step 5, the primary MC system gateway server (202) sends the migration service authorization request to the primary MC server (204).

At step 6, the primary MC server (204) performs the authorization check for the migration service authorization request. At step 7, the primary MC server (204) marks the MC service user as migrated to the partner system. At step 8, the primary MC server (204) sends a migration service authorization response to the primary MC system gateway server (202). Step 9, the primary MC system gateway server (202) sends the migration service authorization response to the partner MC system gateway server (106). At step 10, the partner MC system gateway server (106) sends the migration service authorization response to the partner MC server (104). At step 11, the partner MC server (104) stores the migration information. Unlike conventional methods and systems, the partner MC server (104) stores the migration status along with the mapping of MC service IDs of primary and partner system used for route a call request appropriately only on completing MC service authorization. At step 12, the partner MC server (104) sends the migration service authorization response to the MC client (102).

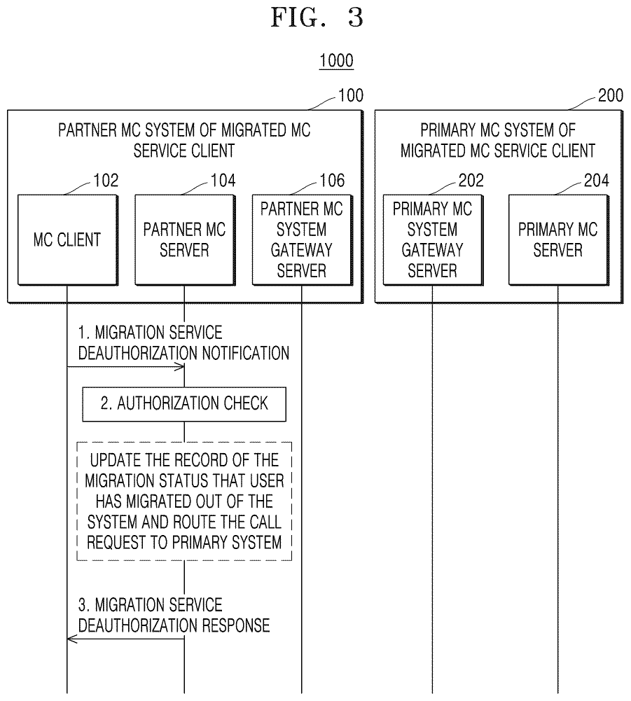

FIG. 3 shows a flow diagram of service de-authorization of migration from the partner MC system (100) to update (e.g. to clear) the stored migration status information from the current migrated MC system, when the migrated MC service user migrates back to its primary MC system (200) or another partner MC system only after completing MC service authorization at migrating MC system according to an embodiment of the disclosure.

When the migrated MC service user return back to the primary MC system (200) or migrate to another partner MC system, the stored necessary information related to the migrated MC service user (e.g., MC service ID of the migrated MC service user provided by the primary MC system (200) mapped to the MC service ID of the migrated MC service user provided by partner MC system and the migration status information of the MC service user) at previously migrated MC system are cleared or updated. The update or clearing of the stored information is performed on receiving of a migration service de-authorization request or notify and will be sent on successful completion of MC service authorization at the primary MC system (200) or another partner MC system to which user is migrating.

The migration service de-authorization is initiated by either MC service user (i.e. MC service client) or primary MC server of the primary MC system of the migrated MC service user. Following different ways are used in conjunction with triggering condition and additional information flows.

Initiated by MC service user: In this scenario, the migration service de-authorization request is sent by the migrated MC service user at the MC client (102) on determining that MC service user is no longer migrated to current partner MC system. The migration service de-authorization request is sent only after completing successful MC service authorization at the newly migrated MC system (i.e. Primary MC system to which the MC service user returned back or another partner MC system to which MC service user has migrated).

Following pre-condition or additional information added for the service deauthorization of migration from partner MC system procedure.

“The MC service user is successfully completed the MC service authorisation at newly migrated MC system (i.e. Primary MC system to which the MC service user returned back or another partner MC system to which MC service user has migrated)” OR “The migration service de-authorization request is sent only after completing successful MC service authorisation at newly migrated MC system (i.e. Primary MC system to which the MC service user returned back or another partner MC system to which MC service user has migrated)”.

As shown in FIG. 3, at step 1, the MC client (102) sends the migration service deauthorization request to the partner MC server (104). At step 2, the partner MC server (104) performs the authorization check. The partner MC server (104) updates the record of the migration status that user has migrated out of the system and routes the call request to the primary MC server (204). At step 3, the partner MC server (104) sends the migration service deauthorization response to the MC client (102).

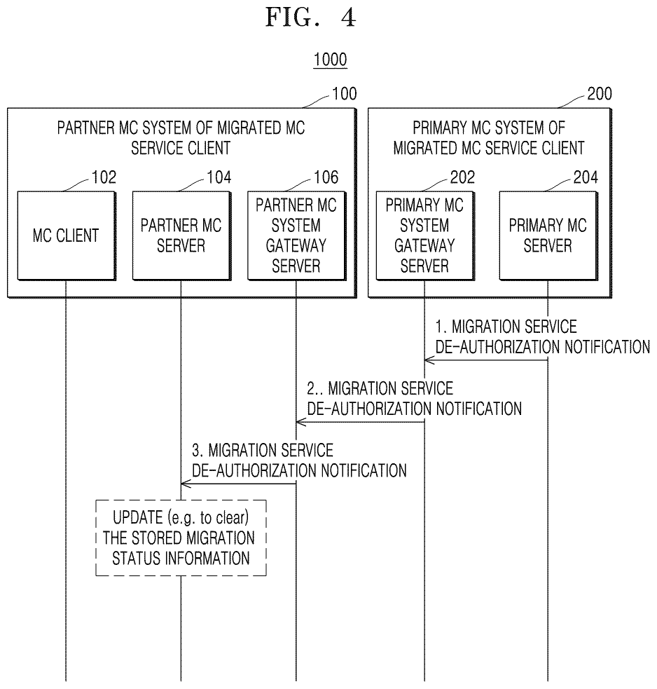

FIG. 4 shows a flow diagram of the service de-authorization request initiated by the primary MC server (204) of the primary MC system (200) of migrated MC service user upon receiving of MC service authorisation request at the primary MC system (200) of migrated MC service user, according to an embodiment of the disclosure.

In this scenario, the migration service de-authorization request is sent by the MC service server of the primary MC system (200) of the migrated MC service user on determining that MC service user migrated back to the primary MC system and on successful completion of MC service authorization.

Following pre-condition or additional information added for the Service deauthorization of migration from partner MC system procedure.

“The MC service user has successfully completed the MC service authorisation at the primary MC system to which the MC service user returned back from migrated MC system” OR “The migration service de-authorization request is sent only after completing successful MC service authorisation at the primary MC system to which the MC service user returned back from migrated MC system”.

As shown in FIG. 4, at step 1, primary MC server (204) sends the migration service de-authorization notification to the primary MC system gateway server (202). At step 2, the primary MC system gateway server (202) sends migration service deauthorization notification to the partner MC system gateway server (106). At step 3, the partner MC system gateway server (106) sends the migration service deauthorization notification to the partner MC server (104). The partner MC server (104) update (e.g. to clear) the stored migration status information.

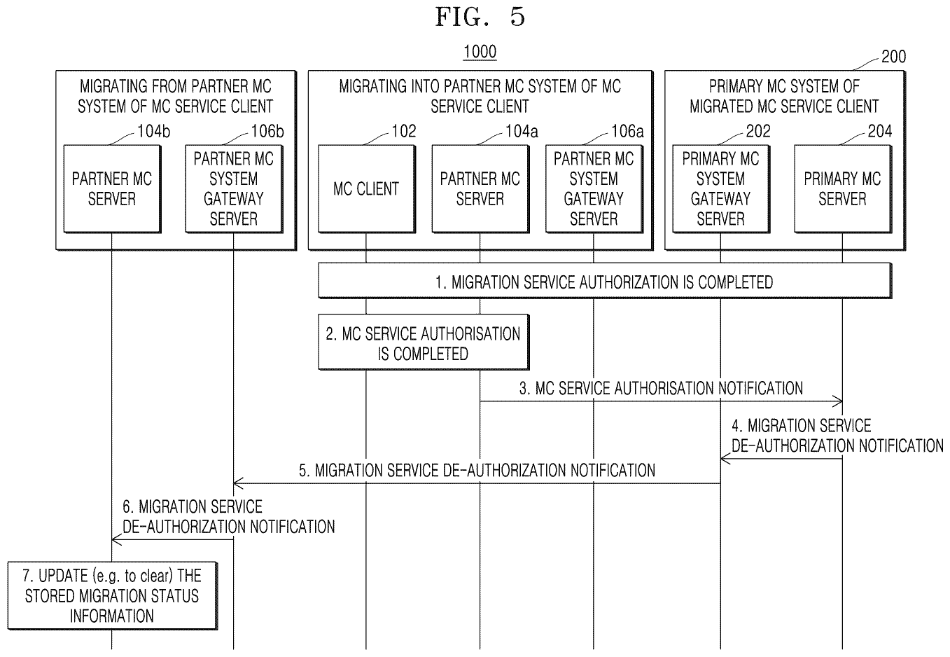

FIG. 5 shows a flow diagram of the service de-authorization request initiated by the primary MC server (204) of the primary MC system (200) of the migrated MC service user upon receiving of MC service authorisation notification at the primary MC system (200) of migrated MC service user from another MC system to which MC service user has migrated, according to an embodiment of the disclosure.

In this scenario, the migration service de-authorization request is sent by the MC service server of the primary MC system of the migrated MC service user on determining that MC service user has migrated to another partner MC system and on receiving of MC service authorization notification from another MC system to which MC service user has migrated.

Following information element, pre-condition or additional information added for the service de-authorization of migration from partner MC system procedure. A new information element is defined to notify the primary MC system that the MC service user after migrating to another MC partner system has successfully completed the MC service authorisation at another MC partner system.

### MC Service Authorisation Notification:

Table X describes the information flow notification for successful completion of the MC service authorisation after migrating to the partner MC system.

TABLE X
MC service authorisation notification

| Information | | |
|---|---|---|
| element | Status | Description |
| MC service ID | M | The MC service ID of the migrating MC |
| | (mandatory) | service user provided by the partner MC |
| | | system. |
| Service | M | Indication to provide the successful |
| authorisation | | completion of MC service authorisation |
| Indication | | after migrating to the partner MC system |

“The MC service user has successfully completed the MC service authorisation at another partner MC system to which MC service user has migrated and notified the primary MC system of migrated MC service user” OR “The migration service deauthorization request is sent by the primary MC system of migrate MC service user only after completing successful MC service authorization at another partner MC system to which the MC service user has migrated and notified the primary MC system of the migrated MC service user”.

As shown in FIG. 5, at step 1, the migration service authorization is completed among the MC client (102), the partner MC server (104a), the partner MC system gateway server (106a), the primary MC system gateway server (202) and the primary MC server (204). At step 2, the MC service authorization is completed between the MC client (102) and the partner MC server (104a). At step 3, the partner MC server (104a) sends the MC service authorization notification to the primary MC server (204). At step 4, the primary MC server (204) sends the migration service de-authorization notification to the primary MC system gateway server (202). At step 5, the primary MC system gateway server (202) sends the migration service de-authorization notification to the partner MC system gateway server (106b). At step 6, the partner MC system gateway server (106b) sends the migration service de-authorization notification to the partner MC server (104b). At step 7. the partner MC server (104b) updates (e.g. to clears) the stored migration status information.

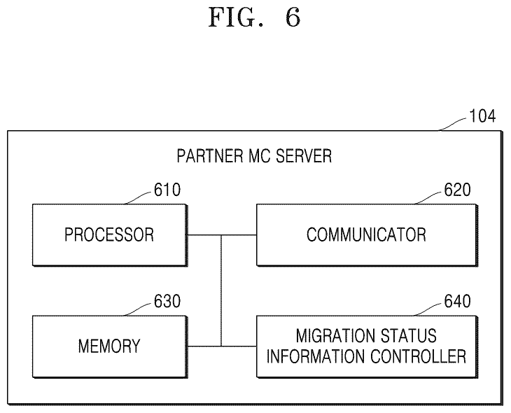

FIG. 6 shows various hardware components of the partner MC server (104), according to an embodiment of the disclosure. In an embodiment of the disclosure, the partner MC server (104) includes a processor (610), a communicator (620), a memory (630) and a migration status information controller (640). The processor (610) is coupled with the communicator (620), the memory (630) and the migration status information controller (640).

The migration status information controller (640) receives the migration service authorization request message for migrating the MC service user associated with the MC client (102). The migration service authorization request message is transmitted to the primary MC server (204) through the partner MC system gateway server (106), and the primary MC system gateway server (202). Further, the migration status information controller (640) transmits the migration service authorization request message for migration service authorisation to the primary MC server (204) for migrating the MC service user. Further, the migration status information controller (640) receives the migration service authorization response message from the primary MC server (204) for successful completion of the migration service authorization when the MC service user is migrated to the partner MC server (104). The migration service authorization response message is received from the primary MC server (204) through the partner MC system gateway server (106) and the primary MC system gateway server (202). The migration service authorization response message includes a migration authorization status information of the MC service user. Further, the migration status information controller (640) stores the migration status information of the MC service user associated with the MC client (102). The migration status information includes the MC service identifier of the MC service user provided by the primary MC system (200) and the partner MC system (100) and the service authorisation indication indicating the successful completion of the MC service authorisation when the MC service user is migrated to the partner MC server (104). Further, the migration status information controller (640) transmits the migration service authorization response message to the MC client (102), when the migration service authorization request message is received from the MC client (102). Further, the migration status information controller (640) receives the MC service authorisation request message for a MC service authorisation by the MC service user associated with the MC client (102). Further, the migration status information controller (640) transmits the MC service authorisation notification to the primary MC server (204) to indicate about successful completion of the MC service authorisation at the partner MC server (104) by migrating the MC service user. Further, the migration status information controller (640) transmits the MC service authorisation response message to the MC client (102), when the MC service authorisation request message is received from the MC client (102). Further, the migration status information controller (640) performs the MC communication with the MC service user based on the stored migration status information of the MC service user. In an embodiment of the disclosure, the MC communication with the MC service user is performed by mapping the MC service identifier of the MC service user available in the stored migration status information of the MC service user to the MC service identifier of at least one of the partner MC server (104) and the primary MC server (204)

Further, the migration status information controller (640) receives the migration service deauthorization request message from the MC service user for deauthorization of the migration of the MC service user from the partner MC server (104). Further, the migration status information controller (640) determines whether the MC client (102) is authorized for migration service deauthorization of the MC service user. Further, the migration status information controller (640) updates the stored status information of the MC service user based on the migration service deauthorization of the MC service user. The updated migration status information of the MC service user allows redirection of the MC communication back to the primary MC system when the migrated MC service user is no longer migrated on the partner MC server (104). Further, the migration status information controller (640) transmits the migration service deauthorization response message to the migrated MC service user.

Further, the migration status information controller (640) receives the MC call information from the MC service user of the partner MC server (104) for migrated MC service user. Further, the migration status information controller (640) routes the MC call information to the primary MC server (204) based on the updated status information of the migrated MC service user.

Further, the migration status information controller (640) receives the migration service deauthorization notification message from the primary MC server (204) for deauthorization of the migration of the MC service user from the partner MC server (104). The migration service deauthorization notification message is received from the primary MC server (204) through a partner MC system gateway server (106) and a primary MC system gateway server (202). Further, the migration status information controller (640) updates the stored status information of the MC service user based on the migration service deauthorization of the MC service user.

The migration status information controller (640) allows the MC service user to migrate from the primary MC system (200) to the partner MC system (100), migrate from the partner MC system (200) to another partner MC system and return back to the primary MC system (200). The MC service users from the partner MC system (100) or another partner MC system or the primary MC system (200) can communicate with the migrated MC service user.

The migration status information controller (640) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (610) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (610) may include multiple cores and is configured to execute the instructions stored in the memory (630). The processor (610) controls the migration status information controller (640) to perform various operations.

The processor (610) is configured to: receive, from a client, a migration service authorization request message, wherein the migration service authorization request message is forwarded to a second server, obtain a migration service authorization response message from the second server, and store information regarding a second mission critical (MC) service identifier (ID) provided by the second server mapped to a first MC service ID provided by the first server, wherein the stored information is used for communication redirection in case of completion of MC service authorization at the first server.

The processor (610) is configured to: in case that the client completes MC service authorization at the second server, obtain a migration service deauthorization notification from the second server, and update the stored information.

The processor (610) is configured to: in case that the client completes MC service authorization at a third server, obtain a migration service deauthorization notification from the second server, wherein the second server obtains a MC service authorization notification from the third server.

Further, the processor (610) is configured to execute instructions stored in the memory (630) and to perform various processes. The communicator (620) is configured for communicating internally between internal hardware components and with external devices via one or more networks. The memory (630) also stores instructions to be executed by the processor (610). The memory (630) may include nonvolatile storage elements. Examples of such non-volatile storage elements may include magnetic hard discs, optical discs, floppy discs, flash memories, or forms of electrically programmable memories (EPROM) or electrically erasable and programmable memories (EEPROM). In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

In an embodiment of the disclosure, the communicator (620) includes an electronic circuit specific to a standard that enables wired or wireless communication. The communicator (620) is configured to communicate internally between internal hardware components of the external devices via one or more networks.

Although the FIG. 6 shows various hardware components of the partner MC server (104) but it is to be understood that other embodiments are not limited thereon. In an embodiment of the disclosure, the partner MC server (104) may include less or more number of components. Further, the labels or names of the components are used only for illustrative purpose and does not limit the scope of the invention. One or more components can be combined together to perform same or substantially similar function in the partner MC server (104).

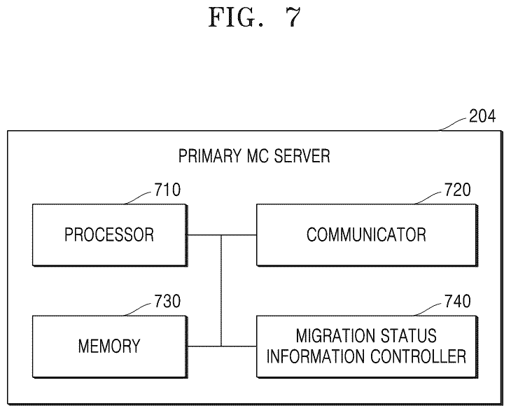

FIG. 7 shows various hardware components of the primary MC server (204), according to an embodiment of the disclosure. In an embodiment of the disclosure, the primary MC server (204) includes a processor (710), a communicator (720), a memory (730) and a migration status information controller (740). The processor (710) is coupled with the communicator (720), the memory (730) and the migration status information controller (740).

The migration status information controller (740) receives the migration service authorization request message from the partner MC server (104). The migration service authorization request message is for migrating the MC service user associated with the MC client (102) to the partner MC server (104). Further, the migration status information controller (740) migrates the MC service user to the partner MC server (104). Further, the migration status information controller (740) performs the migration service authorisation for migrating the MC service user to the partner MC server (104). Further, the migration status information controller (740) stores the migration status information of the MC service user associated with the MC client (102). The migration status information includes the MC service identifier of the MC service user provided by the primary MC system (200) and the partner MC system (100) and a service authorisation indication indicating the successful completion of the MC service authorisation when the MC service user is migrated to the partner MC server (104). Further, the migration status information controller (740) transmits the migration service authorization response message to the partner MC server (104). The migration service authorization response message includes the migration status information of the MC service user. Further, the migration status information controller (740) receives the MC service authorisation notification message to indicate about successful completion of the MC service authorisation at the partner MC server (104) by migrating the MC service user associated with the MC client (102). Further, the migration status information controller (740) performs the MC communication with the MC service user based on the stored migration status information of the MC service user.

Further, the migration status information controller (740) transmits the migration service deauthorization notification message to the partner MC server (104) for deauthorization of the migration of the MC service user from the partner MC server (104). Further, the migration status information controller (740) updates the stored status information of the MC service user based on the migration service deauthorization of the MC service user. The updated migration status information of the MC service user allows redirection of the MC communication appropriately. Further, the migration status information controller receives the migration service deauthorization response message to the migrated MC service user.

Further, the migration status information controller (740) receives the MC service authorisation notification message to indicate about successful completion of the MC service authorisation at current partner MC server (104a) by migrating the MC service user associated with the MC client (102). Further, the migration status information controller (740) transmits the migration service deauthorization notification message to the previous partner MC server (104b) for deauthorization of the migration of the MC service user from the previous partner MC server (104b). Further, the migration status information controller (740) updates the stored status information of the MC service user based on the migration service deauthorization of the MC service user. The updated migration status information of the MC service user allows redirection of the MC communication appropriately. Further, the migration status information controller (740) receives the migration service deauthorization response message to the migrated MC service user.

The migration status information controller (740) allows the MC service user to migrate from the primary MC system (200) to the partner MC system (100), migrate from the partner MC system (100) to another partner MC system and return back to the primary MC system (200). The MC service users from the partner MC system or another partner MC system or primary MC system can communicate with the migrated MC service user.

The migration status information controller (740) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (710) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (710) may include multiple cores and is configured to execute the instructions stored in the memory (730). The processor (710) controls the migration status information controller (740) to perform various operations.

The processor (710) is configured to: obtain a migration service authorization request message from a first server, store information regarding a second mission critical (MC) service identifier (ID) provided by the second server mapped to a first MC service ID provided by the first server, and transmit a migration service authorization response message, wherein the stored information is used for communication redirection in case of completion of MC service authorization at the first server.

The processor (710) is configured to: in case that a client completes MC service authorization at a third server, obtain a MC service authorization notification from the third server, and transmit a migration service deauthorization notification.

Further, the processor (710) is configured to execute instructions stored in the memory (730) and to perform various processes. The communicator (720) is configured for communicating internally between internal hardware components and with external devices via one or more networks. The memory (730) also stores instructions to be executed by the processor (710). The memory (730) may include nonvolatile storage elements. Examples of such non-volatile storage elements may include magnetic hard discs, optical discs, floppy discs, flash memories, or forms of electrically programmable memories (EPROM) or electrically erasable and programmable memories (EEPROM). In addition, the memory (730) may, in some examples, be considered a non-transitory storage medium. The term “non-transitory” may indicate that the storage medium is not embodied in a carrier wave or a propagated signal. However, the term “non-transitory” should not be interpreted that the memory (730) is non-movable. In certain examples, a non-transitory storage medium may store data that can, over time, change (e.g., in Random Access Memory (RAM) or cache).

In an embodiment of the disclosure, the communicator (720) includes an electronic circuit specific to a standard that enables wired or wireless communication. The communicator (720) is configured to communicate internally between internal hardware components of the external devices via one or more networks.

Although the FIG. 7 shows various hardware components of the primary MC server (204) but it is to be understood that other embodiments are not limited thereon. In an embodiment of the disclosure, the primary MC server (204) may include less or more number of components. Further, the labels or names of the components are used only for illustrative purpose and does not limit the scope of the invention. One or more components can be combined together to perform same or substantially similar function in the primary MC server (204).

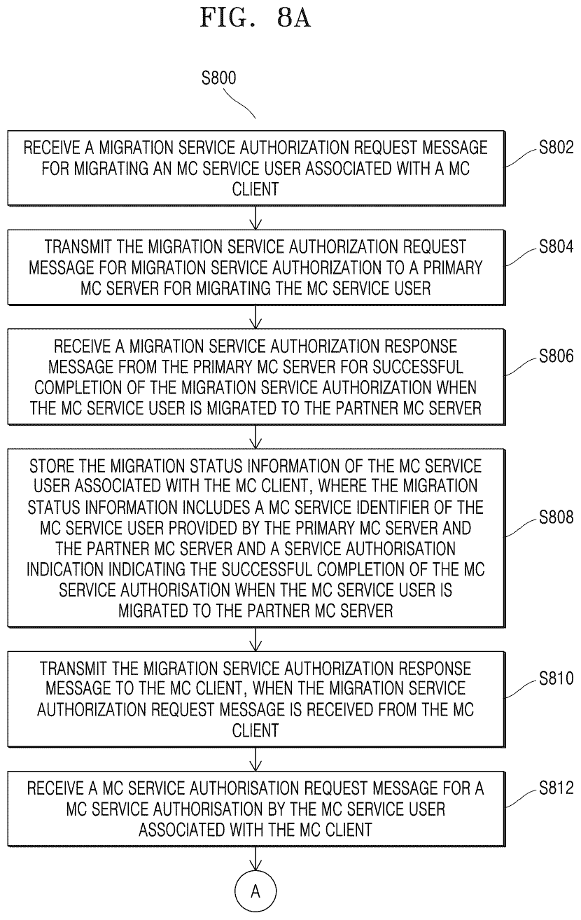

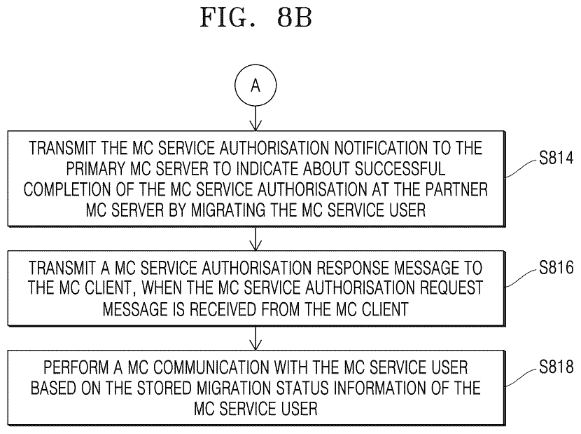

FIG. 8A and FIG. 8B are flow charts (S800) illustrating a method, implemented by the partner MC server (104), for handling migration status information of the MC service user migrating in the MC network (1000), according to an embodiment of the disclosure. The operations (S802-S818) are handled by the migration status information controller (640) and the processor (610).

At S802, the method includes receiving the migration service authorization request message for migrating the MC service user associated with the MC client (102). At S804, the method includes transmitting the migration service authorization request message for migration service authorisation to the primary MC server (204) for migrating the MC service user. At S806, the method includes receiving the migration service authorization response message from the primary MC server (204) for successful completion of the migration service authorization when the MC service user is migrated to the partner MC server (104). The migration service authorization response message includes the migration authorization status information of the MC service user. At S808, the method includes storing the migration status information of the MC service user associated with the MC client (102). The migration status information includes the MC service identifier of the MC service user provided by the primary MC system (200) and the partner MC system (100) and the service authorisation indication indicating the successful completion of the MC service authorisation when the MC service user is migrated to the partner MC server (104).

At S810, the method includes transmitting the migration service authorization response message to the MC client (102), when the migration service authorization request message is received from the MC client (102). At S812, the method includes receiving the MC service authorisation request message for the MC service authorisation by the MC service user associated with the MC client (102). At S814, the method includes transmitting the MC service authorisation notification to the primary MC server (204) to indicate about successful completion of the MC service authorisation at the partner MC server (104) by migrating the MC service user. At S816, the method includes transmitting the MC service authorisation response message to the MC client (102), when the MC service authorisation request message is received from the MC client (102). At S818, the method includes performing a MC communication with the MC service user based on the stored migration status information of the MC service user.

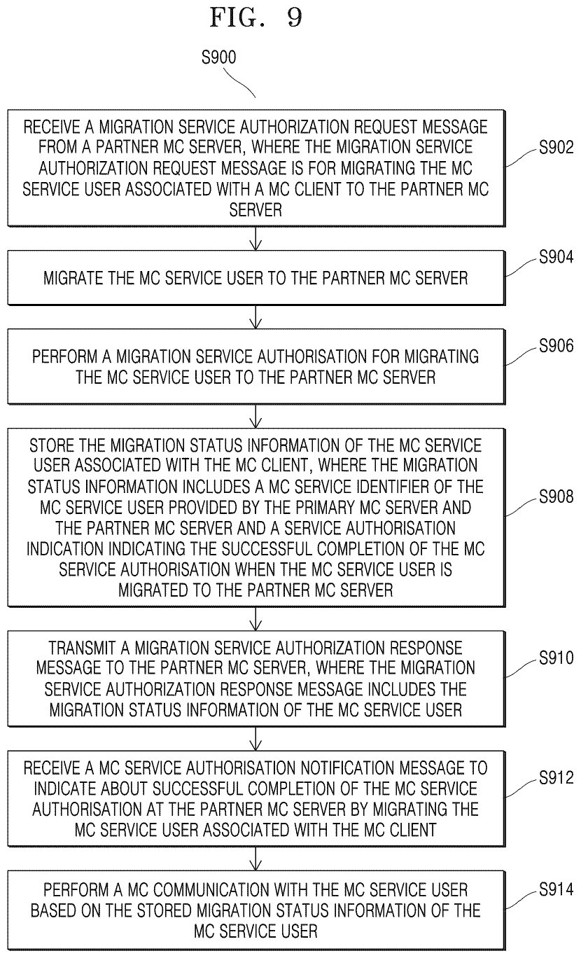

FIG. 9 is a flow chart (S900) illustrating a method, implemented by the primary MC server (204), for handling migration status information of a MC service user migrating in the MC network (1000), according to an embodiment of the disclosure. The operations (S902-S914) are handled by the migration status information controller (740) and the processor (710).

At S902, the method includes receiving the migration service authorization request message from the partner MC server (104). The migration service authorization request message is for migrating the MC service user associated with a MC client (102) to the partner MC server (104). At S904, the method includes migrating the MC service user to the partner MC server (104). At S906, the method includes performing the migration service authorisation for migrating the MC service user to the partner MC server (104). At S908, the method includes storing the migration status information of the MC service user associated with the MC client (102). The migration status information includes the MC service identifier of the MC service user provided by the primary MC system (200) and the partner MC system (100) and a service authorisation indication indicating the successful completion of the MC service authorisation when the MC service user is migrated to the partner MC server (104).

At S910, the method includes transmitting the migration service authorization response message to the partner MC server (104). The migration service authorization response message includes the migration status information of the MC service user. At S912, the method includes receiving the MC service authorisation notification message to indicate about successful completion of the MC service authorisation at the partner MC server (104) by migrating the MC service user associated with the MC client (102). At S914, the method includes performing a MC communication with the MC service user based on the stored migration status information of the MC service user.

In an embodiment of the disclosure, a method performed by a first server comprising: in case that the client completes MC service authorization at the second server, obtaining a migration service deauthorization notification from the second server; and updating the stored information.

In an embodiment of the disclosure, the client returns back from the first server to second server. In an embodiment of the disclosure, a method performed by a second server comprising: in case that a client completes MC service authorization at a third server, obtaining a MC service authorization notification from the third server; and transmitting a migration service deauthorization notification.

In an embodiment of the disclosure, the client migrates to the third server. In an embodiment of the disclosure, the MC service authorization notification comprises a third MC service ID provided by the third server, and an indication indicating completion of the MC service authorization at the third server.

In an embodiment of the disclosure, the at least one processor is configured to: in case that the client completes MC service authorization at the second server, obtain a migration service deauthorization notification from the second server, and update the stored information.

In an embodiment of the disclosure, the at least one processor is configured to: in case that the client completes MC service authorization at a third server, obtain a migration service deauthorization notification from the second server, wherein the second server obtains a MC service authorization notification from the third server.

In an embodiment of the disclosure, the at least one processor is configured to: in case that a client completes MC service authorization at a third server, obtain a MC service authorization notification from the third server, and transmit a migration service deauthorization notification.

The various actions, acts, blocks, steps, or the like in the flow charts (S800 and S900) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a first server, the method comprising:
receiving, from a client, a migration service authorization request message to be forwarded to a second server;
obtaining a migration service authorization response message from the second server; and
storing information regarding a second mission critical (MC) service identifier (ID) provided by the second server mapped to a first MC service ID provided by the first server,
wherein the stored information is used for communication redirection in case of completion of MC service authorization at the first server.

2. The method of claim 1, further comprising:
in case that the client completes MC service authorization at the second server, obtaining a migration service deauthorization notification from the second server; and
updating the stored information.

3. The method of claim 2, wherein the client returns back from the first server to second server.

4. A method performed by a second server, the method comprising:
obtaining a migration service authorization request message from a first server;
storing information regarding a second mission critical (MC) service identifier (ID) provided by the second server mapped to a first MC service ID provided by the first server; and
transmitting a migration service authorization response message to be forwarded to the first server,
wherein the stored information is used for communication redirection in case of completion of MC service authorization at the first server.

5. The method of claim 4, further comprising:
in case that a client completes MC service authorization at a third server, obtaining a MC service authorization notification from the third server; and
transmitting a migration service deauthorization notification to be forwarded to the first server.

6. The method of claim 5, wherein the client migrates to the third server.

7. The method of claim 5, wherein the MC service authorization notification comprises a third MC service ID provided by the third server,
and an indication indicating completion of the MC service authorization at the third server.

8. A first server comprising:
a transceiver; and
at least one processor coupled to the transceiver, configured to:
receive, from a client, a migration service authorization request message, wherein the migration service authorization request message is forwarded to a second server,
obtain a migration service authorization response message from the second server, and
store information regarding a second mission critical (MC) service identifier (ID) provided by the second server mapped to a first MC service ID provided by the first server,
wherein the stored information is used for communication redirection in case of completion of MC service authorization at the first server.

9. The first server of claim 8, wherein the at least one processor is further configured to:
in case that the client completes MC service authorization at the second server, obtain a migration service deauthorization notification from the second server, and
update the stored information.

10. The first server of claim 9, wherein the client returns back from the first server to second server.

11. The first server of claim 8, wherein the at least one processor is further configured to:
in case that the client completes MC service authorization at a third server, obtain a migration service deauthorization notification from the second server,
wherein the second server obtains a MC service authorization notification from the third server.

12. A second server comprising:
a transceiver; and
at least one processor coupled to the transceiver, configured to:
obtain a migration service authorization request message from a first server,
store information regarding a second mission critical (MC) service identifier (ID) provided by the second server mapped to a first MC service ID provided by the first server, and
transmit a migration service authorization response message,
wherein the stored information is used for communication redirection in case of completion of MC service authorization at the first server.

13. The second server of claim 12, wherein the at least one processor is further configured to:
in case that a client completes MC service authorization at a third server, obtain a MC service authorization notification from the third server, and
transmit a migration service deauthorization notification.

14. The second server of claim 13, wherein the client migrates to the third server.

15. The second server of claim 13, wherein the MC service authorization notification comprises a third MC service ID provided by the third server, and an indication indicating completion of the MC service authorization at the third server.
